(19) United States
(12) Patent Application Publication
(10) Pub. No.: US 2014/0379982 A1
(43) Pub. Date: Dec. 25, 2014

(54) SEMICONDUCTOR MEMORY DEVICE AND MEMORY SYSTEM INCLUDING THE SAME

(71) Applicant: SK hynix Inc., Gyeonggi-do (KR)

(72) Inventor: Sang Oh LIM, Gyeonggi-do (KR)

(73) Assignee: SK hynix Inc., Gyeonggi-do (KR)

(21) Appl. No.: 14/064,015

(22) Filed: Oct. 25, 2013

(30) Foreign Application Priority Data
Jun. 24, 2013 (KR) 10-2013-0072410

(51) Int. Cl. G06F 3/06

(52) U.S. Cl. CPC G06F 3/0658; G06F 3/0688; G06F 3/0619
USPC 711/114

(57) ABSTRACT

A semiconductor memory device and a memory system including the same are provided. The semiconductor memory device, includes a memory cell array including a plurality of memory cells, a read and write circuit configured to store read data by sensing data stored in the plurality of memory cells and output the read data to input/output data lines in response to data read control signals, in a read operation, and an output controller configured to control the data read control signals so that activation intervals of the data read control signals generated in a cache read operation of the read operation are longer than those generated in a normal read operation of the read operation.

### CROSS-REFERENCE TO RELATED APPLICATION

The present application claims priority of Korean patent application number 10-2013-0072410, filed on Jun. 24, 2013, in the Korean Intellectual Property Office, the entire disclosure of which is incorporated herein by reference in its entirety.

### BACKGROUND

1. Field of Invention

The present invention relates to a semiconductor memory device, and a memory system including the same.

2. Description of Related Art

A semiconductor memory device is divided into a volatile semiconductor memory device and a non-volatile semiconductor memory device. The volatile semiconductor memory device may include a dynamic random access memory and a static random access memory. The volatile semiconductor memory device has a high read and write speed, but stored data disappear when an external power supply is cut off. The non-volatile semiconductor memory device may include a Mask Read-Only Memory (MROM), a Programmable Read-Only Memory (PROM), an Erasable Programmable Read-Only Memory (EPROM), an Electrically Erasable Programmable Read-Only Memory (EEPROM), and the like. The non-volatile semiconductor memory device maintains data even when an external power supply is cut off. Therefore, the non-volatile semiconductor memory device is used to store data to be remained regardless of whether the power supply is provided or not.

However, since the MROM, the PROM, and the EPROM are not free to erase and write data autonomously due to the nature of the system, it is not easy for the general users to renew the stored data. Meanwhile, since the EEPROM can electrically erase and write data, application in system programming or an auxiliary storage device that requires a continuous update is being expanded. Especially, since the flash memory device has a degree of integration higher than a conventional EEPROM, the flash memory device has an advantage to use as a high capacity auxiliary storage device. In particular, a NAND-type flash memory device has the degree of integration higher than a NOR-type flash memory device.

In addition to the highly integrated NAND-type flash memory device, a need of a memory system for controlling the flash memory has been increased according to the development of mobile systems and various kinds of applications. As described above, the flash memory device can store a large capacity of data information, but has a data read and write time a little longer than RAM. Performance of the system including the flash memory device is limited by a read operation time of the flash memory device, The restriction of the system performance by the flash memory device may be solved by supporting a cache read operation.

### BRIEF SUMMARY

An embodiment of the present invention provides a semiconductor memory device that can output data stably, even though a power drop phenomenon occurs due to a peak current in a cache read operation of the semiconductor memory device, and a memory system including the same.

One aspect of the present invention provides a semiconductor memory device, including: a memory cell array including a plurality of memory cells; a read and write circuit configured to store read data by sensing data stored in the plurality of memory cells and output the read data to input/output data lines in response to data read control signals, in a read operation; and an output controller configured to generate the data read control signals so that activation intervals of the data read control signals generated in a cache read operation of the read operation are longer than those generated in a normal read operation of the read operation.

Another aspect of the present invention provides a semiconductor memory device, including: a memory cell array including a plurality of memory cells; a read and write circuit configured to store read data by sensing data stored in the plurality of memory cells and output the read data to input/output data lines in response to data read control signals; an I/O sense amplifier configured to receive the read data through the input/output data lines, and output the read data to the global data line in response to the input/output strobe signal; and an output controller configured to output an expanded data read control signals and an expanded input/output strobe signal by expanding activation intervals of the data read control signals and the input/output strobe signal in response to a cache read flag signal activated in a cache read operation.

Still another aspect of the present invention provides a memory system, comprising: a semiconductor memory device including a plurality of memory cells, a read and write circuit connected to the plurality of memory cells through bit lines, and input output data lines connected to the read and write circuit; and a controller configured to control the semiconductor memory device, wherein the semiconductor memory device reads data stored in the selected memory cells in response to a request of a read operation from the controller, stores the read data in the read and write circuit, and controls a length of an interval transmitting the read data to the input/output data lines depending on whether the read operation is a normal read operation or a cache read operation.

According to the present invention, even though a power drop phenomenon occurs due to a peak current in a cache read operation of a semiconductor memory device, a data output operation can be stably performed by expanding an activation interval of an internal clock for controlling the data output.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram illustrating a memory system including a semiconductor memory device.

FIG. 2 is a block diagram more detailedly illustrating the semiconductor memory device of FIG. 1,

FIG. 3 is a block diagram illustrating an output controller according to an embodiment of the present invention.

FIG. 4 is a detailed circuit diagram illustrating an I/O sense amplifier.

FIG. 5 is a circuit diagram illustrating a connection relation between a plurality of page buffers and input/output lines.

FIG. 6 is a waveform diagram of signals illustrating a data read operation according to an embodiment of the present invention.

FIG. 7 is a block diagram illustrating an output controller according to another embodiment of the present invention.

FIG. 8 is a diagram illustrating a configuration of a first delay unit of FIG. 7.

FIG. 9 is a diagram illustrating a configuration of the second delay unit of FIG. 7.

FIG. 10 is a waveform diagram of signals illustrating a data read operation according to another embodiment of the present invention.

FIG. 11 is a block diagram illustrating a memory system including the semiconductor memory device of FIG. 1.

FIG. 12 is a block diagram illustrating an application example of the memory system of FIG. 11.

FIG. 13 is a block diagram illustrating a computing system including the application example of FIG. 12.

### DESCRIPTION OF EMBODIMENTS

The advantages, features, and method of achieving thereof according to the present invention will be made clear by describing example embodiments of the present invention below with reference to the accompanying drawings. Throughout the disclosure, reference numerals correspond directly to the like numbered parts in the various figures and embodiments of the present invention. However, the embodiments of the present invention are described below in sufficient detail to enable those of ordinary skill in the art to embody and practice the present invention. Although embodiments have been described with reference to a number of illustrative embodiments thereof, it should be understood that numerous other modifications and embodiments may be devised by those skilled in the art that will fall within the spirit and scope of the principles of this disclosure.

Throughout the specification, when a part is referred to as being “connected” to another element, it can be “directly connected” to the other part or “indirectly connected” with an element there between. In the specification, when a part is referred to as “including” an element, the term “including” means that one or more corresponding components may exist unless they are specifically described to the contrary, it shall be construed that one or more other components can be included.

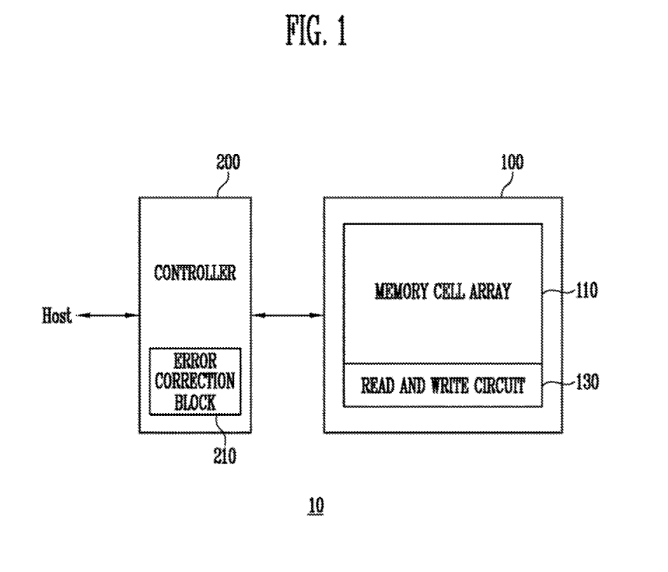

FIG. 1 is a block diagram illustrating a memory system 10 including a semiconductor memory device 100.

With reference to FIG. 1, the memory system 10 includes a semiconductor memory device 100 and a controller 200. The semiconductor memory device 100 includes a memory cell array 110 and a read and write circuit 130 connected to the memory cell array 110.

The memory cell array 110 may include a plurality of memory cells. Each of the memory cells may be defined as a single-level memory cell that stores one bit of data or a multi-level memory cell that stores two or more bits of data.

The semiconductor memory device 100 may operate under the control of the controller 200. The semiconductor memory device 100 may be configured to perform a read operation in response to a read request of the controller 200. When a read command or an address are received from the controller 200, the semiconductor memory device 100 may be configured to perform the read operation with respect to memory cells (i.e., selected memory cells) indicated by the address.

For example, when the read command with respect to the selected memory cells is received, the semiconductor memory device 100 may perform the read operation from the selected memory cells and provide the read data to the controller 200.

According to an embodiment, the semiconductor memory device 100 may be a flash memory device. However, it should be understood that the technical idea of the present invention is not limited to the flash memory device.

The controller 200 may be connected between the semiconductor memory device 100 and the host. The controller 200 may be configured to interface the host and the semiconductor memory device 100. For example, when a read or program operation is performed at the request of the host, the controller 200 may convert a logical block address received from the host into a physical block address, and provide the converted physical block address to the semiconductor memory device 100 together with a corresponding command.

According to an embodiment, the controller 200 may include an error correction block 210. The error correction block 210 may be configured to detect and correct an error of data received from the semiconductor memory device 100. The error correction function performed by the error correction block 210 is limited depending on the number of error bits received from the semiconductor memory device 100. If the number of the error bits in the data received from the semiconductor memory device 100 is smaller than a certain value, the error correction block 210 may perform the error detection and correction function. If the number of the error bits in the data received from the semiconductor memory device 100 is larger than the certain value, the error correction block 210 may not perform the error detection and correction function. When the error detection and correction function is not performed, the controller 200 may control the semiconductor memory device 100 to adjust a voltage applied to the selected word line

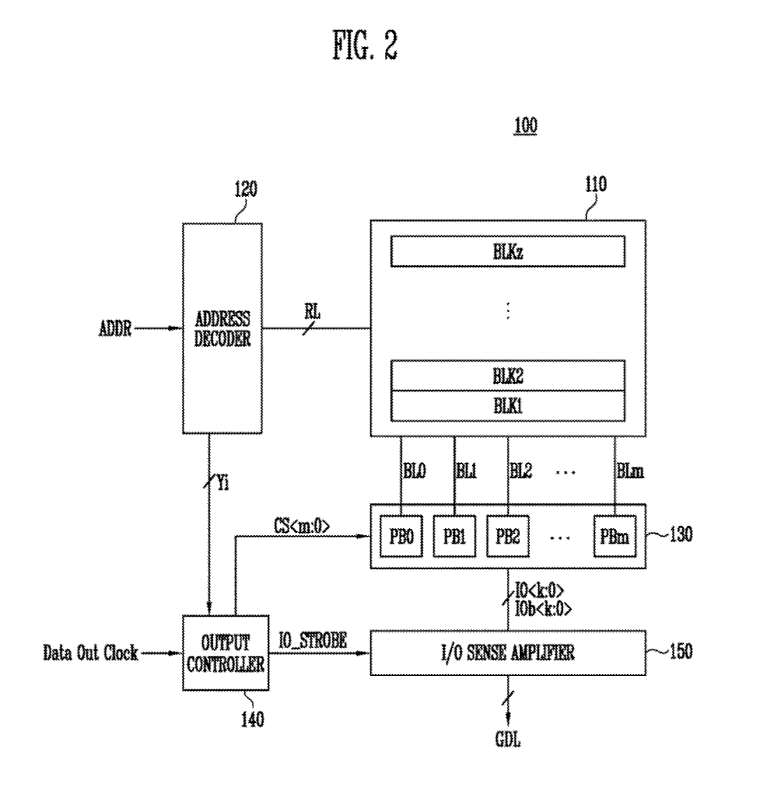

FIG. 2 is a block diagram more detailedly illustrating the semiconductor memory device 100 of FIG. 1.

With reference to FIG. 2, the semiconductor memory device 100 includes the memory cell array 110, an address decoder 120, the read and write circuit 130, an output controller 140, and an I/O sense amplifier 150.

The memory cell array 110 may include a plurality of memory blocks BLK1 to BLKz. The plurality of memory blocks BLK1 to BLKz may be connected to the address decoder 120 through row lines RL. The plurality of memory blocks BLK1 to BLKz may be connected to the read and write circuit 130 through the bit lines BL0 to BLm. Each of the plurality of memory blocks BLK1 to BLKz may include a plurality of memory cells. According to an embodiment, the plurality of memory cells may be non-volatile memory cells.

The address decoder 120 and the read and write circuit 130 may serve as peripheral circuits which drive the memory cell array 110.

The address decoder 120 may be connected to the memory cell array 110 through the row lines RL. The address decoder 120 may receive an address ADDR through an input/output buffer (not shown) inside the semiconductor memory device 100. The address ADDR may be provided from the controller 200 (see FIG. 1).

The address decoder 120 may be configured to decode a block address included in the received address ADDR. The address decoder 120 may select one least one memory block according to the decoded block address.

The address decoder 120 may be configured to decode a row address among the received addresses ADDR. The address decoder 120 may be configured to drive a row line connected to the memory block selected by the decoded row address.

The address decoder 120 may be configured to decode a column address among the received address ADDR. The address decoder 120 may transmit the decoded column address Yi to the output controller 140.

The read operation of the semiconductor memory device 100 is performed by a page unit. The address ADDR received at the time of the read request may include a block address, a row address, and a column address. The address decoder 120 may select one memory block and one word line according to the block address and the row address. The column address Yi may be decoded by the address decoder 120 and provided to the output controller 140.

The read and write circuit 130 may include a plurality of page buffers PB0 to PBm. The plurality of page buffers PB0 to PBm may be connected to the memory cell array 110 through the bit lines BL0 to BLm. The plurality of page buffers PB0 to PBm may sense threshold voltages of the memory cells in the read operation, and latch corresponding data as read data.

The read and write circuit 130 may transmit read data stored in cache latches of the plurality of page buffers PB0 to PBm to input/output lines IO<k:0> and IOb<k:0 in response to read control signals CS<m:0> provided by the output controller 140 in the read operation and >.

The output controller 140 may generate an input/output strobe signal IO_STROBE using a data out clock in the read operation, and generate the read control signals CS<m:0> in response to the data out clock and the column address Yi.

The output controller 140 may change pulse widths of the read control signals CS<m:0> and a pulse width of the input/output strobe signal IO_STROBE generated in a normal read operation and a cache read operation, respectively. For example, the output controller 140 may control to generate the pulse widths of the read control signals CS<m:0> and the pulse width of the input/output strobe signal IO_STROBE in the cache read operation larger than those in the normal read operation.

The I/O sense amplifier 150 may sense read data by sensing potentials of the input/output lines IO<k:0> and IOb<k:0> in response to the input/output strobe signal IO_STROBE in the read operation and transmit the sensed read data to a global data line GDL.

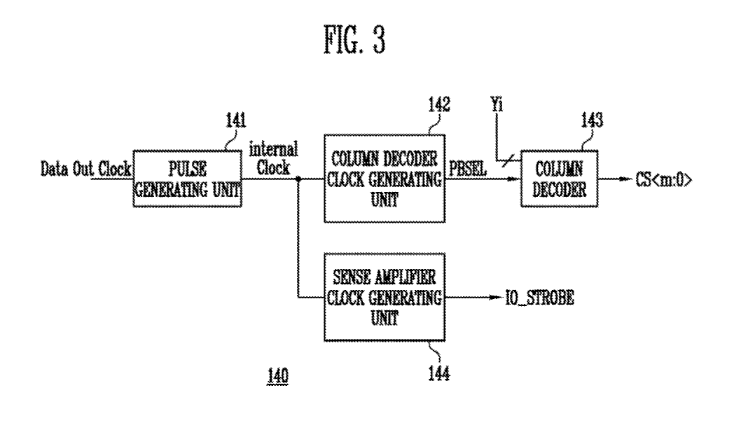

FIG. 3 is a block diagram illustrating an output controller according to an embodiment of the present invention.

With reference to FIG. 3, the output controller 140 includes a pulse generating unit 141, a column decoder clock generating unit 142, a column decoder 143, and a sense amplifier clock generating unit 144.

The pulse generating unit 141 may generate an internal clock in response to the data out clock.

The column decoder clock generating unit 142 may generate a page buffer selecting signal PBSEL in response to the internal clock.

The column decoder 143 may generate the read control signals CS<m:0> to selectively transmit read data stored in the plurality of page buffers PB0 to PBm of the read and write circuit 130 to the input/output lines IO<k:0> and IOb<k:0> in response to the page buffer selecting signal PBSEL and the column address Yi.

The sense amplifier clock generating unit 144 may generate the input/output strobe signal IO_STROBE to drive the I/O sense amplifier 150 in response to the internal clock.

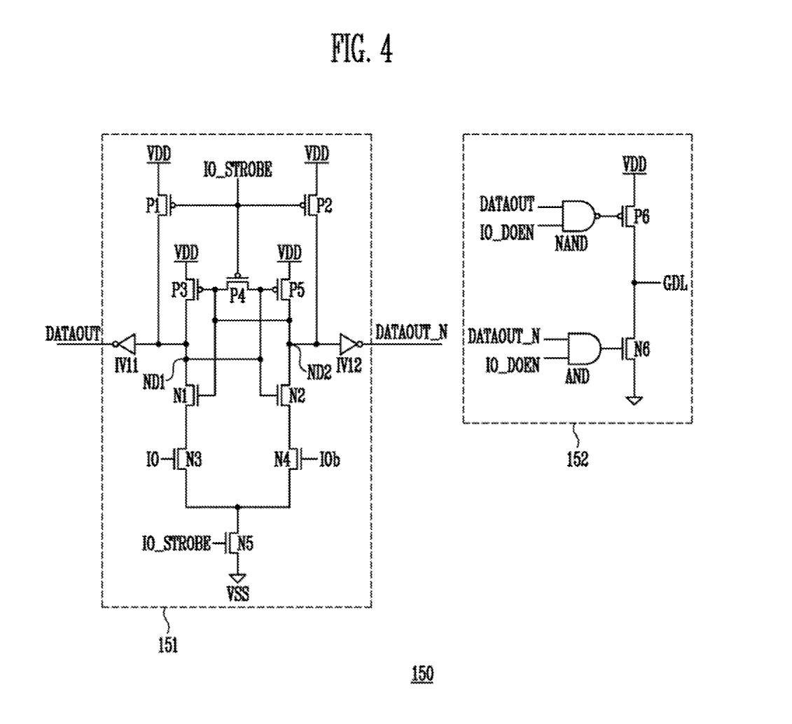

FIG. 4 is a detailed circuit diagram illustrating an I/O sense amplifier.

With reference to FIG. 4, the I/O sense amplifier 150 includes a data sensing unit 151 and a data output unit 152.

The data sensing unit 151 may have a current mirror structure including NMOS transistors N3 and N4 which have the gates to which data input output lines IO and IOb having opposite potential levels are connected respectively, a PMOS transistor P3 and an NMOS transistor N1 which are connected in series by a first node ND1 between a power voltage VDD supply terminal and the NMOS transistor N3 and have the gates to which a potential of a second node ND2 is applied in a cross-coupled structure, a PMOS transistor P5 and an NMOS transistor N2 which are connected in series by the second node ND2 between the power voltage VDD supply terminal and the NMOS transistor N3 and have the gates to which a potential of the first node ND1 is applied in a cross-coupled structure, an NMOS transistor N5 which is connected between a common drain connection node of the NMOS transistors N3 and N4 and the ground, and has a gate to which the input/output strobe signal IO_STROBE is applied, and inverters IV1 and IV2 which invert and amplify potentials of the first and second nodes ND1 and ND2 to output a data output signal DATAOUT and an inverted data output signal DATAOUT_N.

The data sensing unit 151 may further include PMOS transistors P1 and P2 controlled in response to the input/output strobe signal IO_STROBE to selectively transmit the power voltage VDD to each of the first and second nodes ND1 and ND2, and a PMOS transistor P4 controlled in response to the input/output strobe signal IO_STROBE to connect the gates of the PMOS transistor P3 and the PMOS transistor P5.

The data output unit 152 may include a PMOS transistor P6 and an NMOS transistor N6 which are connected in series between the power voltage VDD and the ground, a NAND gate NAND that logically combines a data output enable signal IO_DOEN and the data out signal DATAOUT generated by the data sensing unit 151 to apply an output signal to the gate of the PMOS transistor P6, and an AND gate AND that logically combines the data output enable signal IO_DOEN and the inverted data out signal DATAOUT_N generated in the data sensing unit 151 to apply an output signal to the gate of the NMOS transistor N6.

That is, the data output unit 152 may be activated in response to the data output enable signal IO_DOEN activated in the read operation, and output data of a logic high level or a logic low level to the global data line GDL through an output node between the PMOS transistor P6 and the NMOS transistor N6 in response to the data out signal DATAOUT and the inverted data out signal DATAOUT_N. For example, If the data out signal DATAOUT and the inverted data out signal DATAOUT_N have the high level and the low level, respectively, data of the logic high level may be output to the global data line GDL and if the data out signal DATAOUT and the inverted data out signal DATAOUT_N have the logic low level and the logic high level, respectively, data of the logic low level may be output to the global data line GDL.

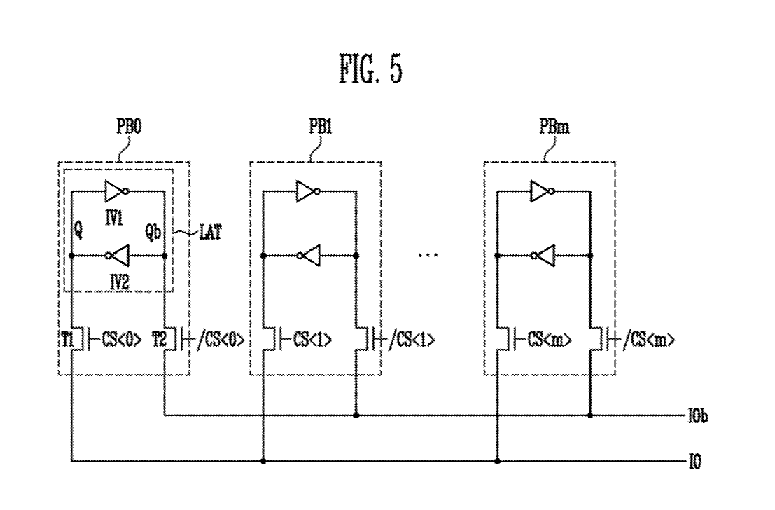

FIG. 5 is a circuit diagram illustrating a connection relation between a plurality of page buffers and input/output lines.

With reference to FIG. 5, cache latches LAT of the plurality of page buffers PB0 to PBm are connected to the input/output line IO and the input/output sub-line IOb through first and second switches T1 and T2, respectively. The first and second switches T1 and T2 of the plurality of page buffers PB0 to PBm transmit read data stored in the cache latches LAT to the input/output line IO or the input/output sub-line IOb in response to read control signals CS<m:0> and inverted read control signals /CS<m:0>.

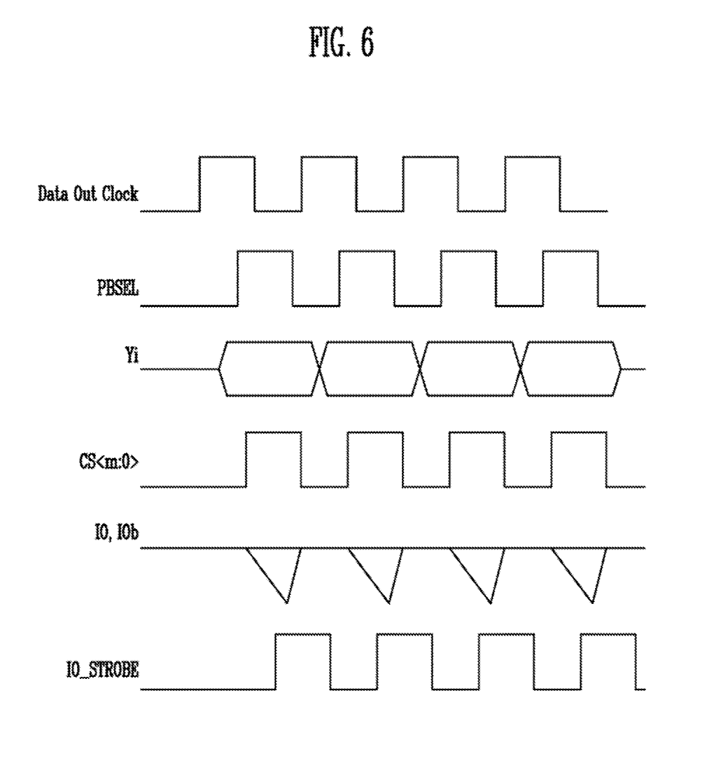

FIG. 6 is a waveform diagram of signals illustrating a data read operation according to an embodiment of the present invention.

With reference to FIGS. 2 to 6, a normal read operation is described as follows.

First, the plurality of page buffers PB0 to PBm of the read and write circuit 130 is connected to the memory cell array 110 through the bit lines BL0 to BLm in the read operation. The plurality of page buffers PB0 to PBm may sense the threshold voltages of the memory cells in the read operation and store corresponding data to the cache latches as read data.

The output controller 140 may generate the input/output strobe signal IO_STROBE using a data out clock with a constant period in the read operation and generate the read control signals CS<m:0> toggling with a constant period in response to the data out clock and the column address Yi.

The plurality of page buffers PB0 to PBm may transmit data stored in the cache latches to the input output data lines IO and IOb in response to the read control signals CS<m:0>.

The I/O sense amplifier 150 may sense read data by sensing potentials of the input output data lines IO and IOb in response to the input/output strobe signal IO_STROBE in the read operation, and transmit the sensed read data to the global data line GDL.

In the normal read operation described above, the read data latched in the cache latches may be transmitted to the input output data lines IO and IOb during the read control signals CS<m:0> generated by the output controller 140 have the high level.

However, in the cache read operation having a data output operation time generally slower than the normal read operation, when the toggle period of the read control signals CS<m:0> used in the normal read operation is used, a power drop of the page buffer occurs. Therefore, if the driving speed of the input output data lines IO and IOb is decreased, an error may occur in the data read operation.

FIG. 7 is a block diagram illustrating an output controller according to another embodiment of the present invention.

With reference to FIG. 7, the output controller 140 includes a pulse generating unit 141, a column decoder clock generating unit 142, a column decoder 143, a sense amplifier clock generating unit 144, a first delay unit 145, and a second delay unit 146.

The pulse generating unit 141 may generate an internal clock in response to a data out clock.

The first delay unit 145 may output a delay clock without changing a period of the internal clock in a normal read operation and output the delay clock by expanding an activation interval of the internal clock in a cache read operation.

The column decoder clock generating unit 142 may generate the page buffer selecting signal PBSEL in response to the delay clock.

The column decoder 143 may generate the read control signals CS<m:0> to selectively transmit read data stored in the plurality of page buffers PB0 to PBm of the read and write circuit 130 to the input/output lines IO<k:0> and IOb<k:0> in response to the page buffer selecting signal PBSEL and the column address Yi. The column decoder 143 may adjust and output the activation interval of the read control signals CS<m:0> so that the activation interval having the logic high level of the read control signals CS<m:0> output in the cache read operation is longer than that in the normal read operation.

The sense amplifier clock generating unit 144 may generate an initial input/output strobe signal int_IO_STROBE in response to the delay clock.

The second delay unit 146 may generate an output strobe signal IC_STROBE without changing a period of the initial input/output strobe signal int_IO_STROBE in the normal read operation, and generate the output strobe signal IO_STROBE by expanding the activation interval of the initial input/output strobe signal int_IO_STROBE in the cache read operation.

The first delay unit 145 and the second delay unit 146 may be desirable to control times of the activation intervals to be the same.

The first delay unit 145 and the second delay unit 146 are enabled by a cache read flag signal CACHEREAD_FLAG that is activated during the cache read operation. During the normal read operation where the cache read flag signal CACHEREAD_FLAG is deactivated, the first delay unit 145 and the second delay unit 146 are disabled and the output controller 140 may perform the same operation as the output controller 140 illustrated in FIG. 3

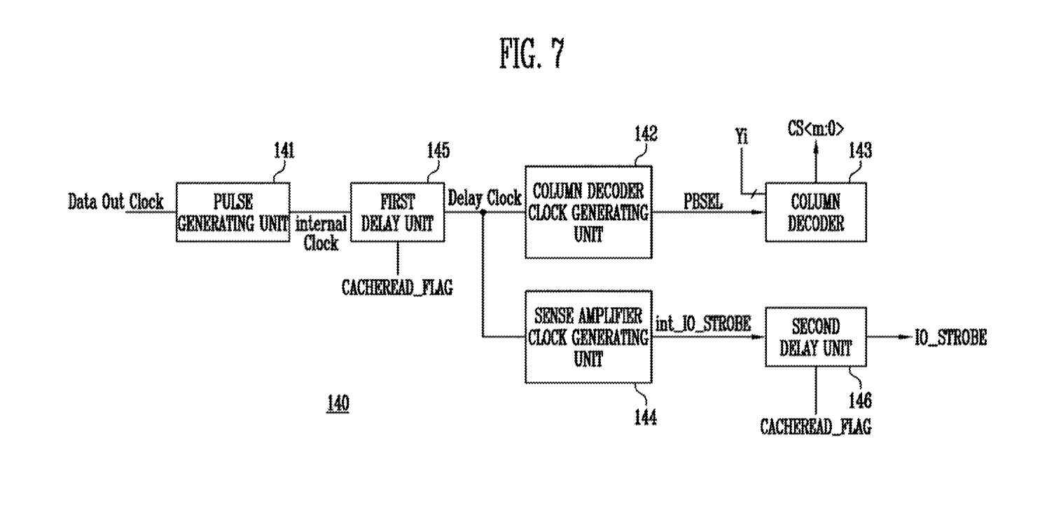

FIG. 8 is a diagram illustrating a configuration of a first delay unit of FIG. 7.

With reference to FIG. 8, the first delay unit 145 includes a delayer 145D and a multiplexer MUX. The delayer 145D may expand the activation interval of the internal clock and output the expanded internal clock to the multiplexer MUX. The multiplexer MUX may output the internal clock or the expanded internal clock having the activation interval expanded by the delayer 145D as a delay clock in response to a cache read flag signal CACHEREAD_FLAG activated in the cache read operation.

The delayer 145D may further include inverters at an input terminal and an output terminal, respectively.

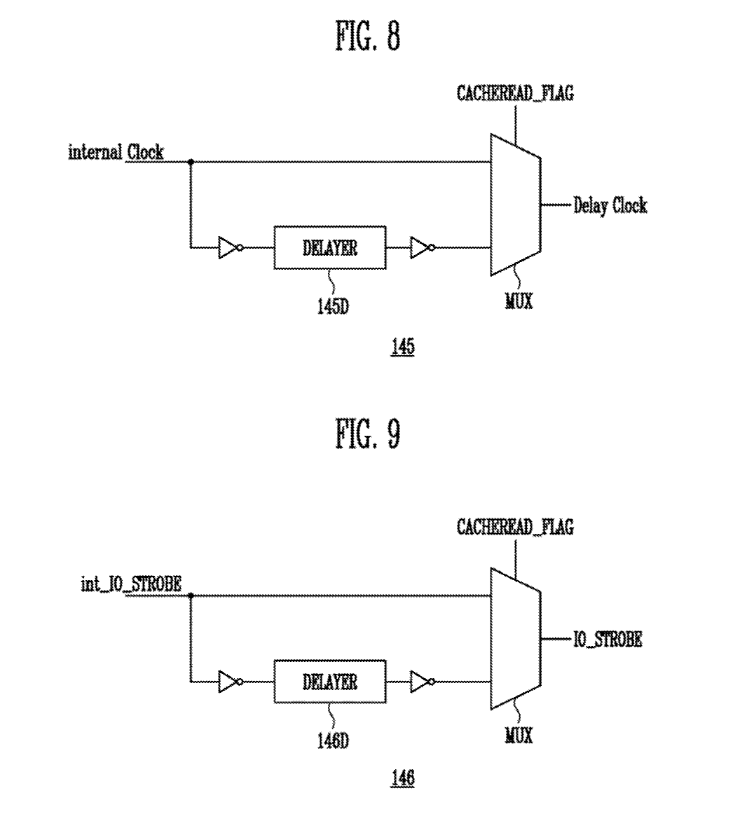

FIG. 9 is a diagram illustrating a configuration of the second delay unit of FIG. 7.

With reference to FIG. 9, the second delay unit 146 includes a delayer 146D and a multiplexer MUX. The delayer 146D may expand the activation interval of the initial input/output strobe signal int_IO_STROBE and output the expanded inital input/output strobe signal to the multiplexer MUX. The multiplexer MUX may output the initial input/output strobe signal int_IO_STROBE or the expanded initial input/output strobe signal having the activation interval expanded by the delayer 146D as the input/output strobe signal IO_STROBE in response to the cache read flag signal CACHEREAD_FLAG activated in the cache read operation.

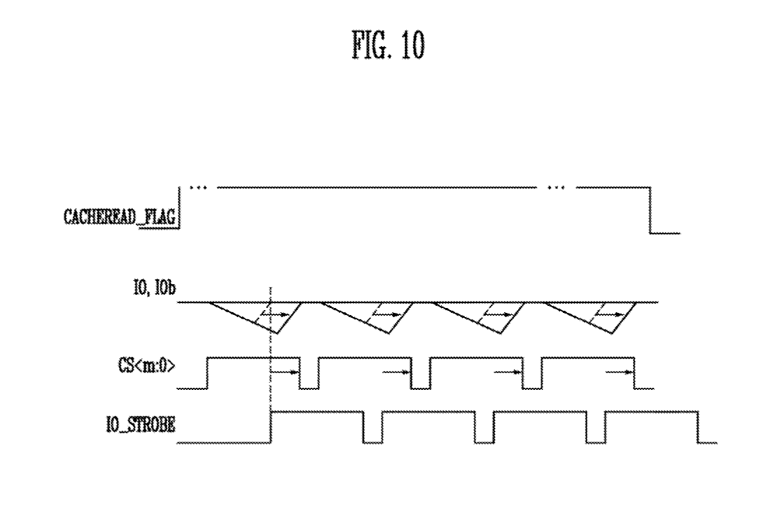

FIG. 10 is a waveform diagram of signals illustrating a data read operation according to another embodiment of the present invention.

With reference to FIGS. 2, 4, 5, and 7 to 10, the cache read operation is described as follows.

Firstly, the plurality of page buffers PB0 to PBm of the read and write circuit 130 is connected to the memory cell array 110 through the bit lines BL0 to BLm in the read operation. The plurality of page buffers PB0 to PBm sense threshold voltages of the memory cells in the read operation, and store corresponding data to the cache latches as read data.

The output controller 140 may generate the input/output strobe signal IO_STROBE having the activation interval expanded more than that in the normal read operation using a data out clock with a constant period in the read operation, and generate the read control signals CS<m:0> toggling with a constant period in response to the data out clock and the column address Yi. At this time, the column decoder 143 may adjust and output the activation interval of the read control signals CS<m:0> so that the activation interval having the logic high level of the read control signals CS<m:0> output in the cache read operation are in the high logic level is longer than that in the normal read operation.

The plurality of page buffers PB0 to PBm may transmit the data stored in the cache latches to the input output data lines IO and IOb in response to the read control signals CS<m:0>. At this time, since the activation interval of the read control signals CS<m:0> is expanded more than that in the normal read operation, the driving intervals of the input output data lines IO and IOb are expanded as illustrated in FIG. 10, so that the data may be stably transmitted.

The I/O sense amplifier 150 may sense read data by sensing potentials of the input output data lines IO and IOb in response to the input/output strobe signal IO_STROBE in the read operation, and transmit the sensed read data to the global data line GDL.

The I/O sense amplifier 150 may sense the potentials of the data lines IO and IOb with an exact timing under the condition that the driving intervals of the data lines IO and IOb in the cache read operation are longer than those in the normal read operation, due to the fact that read control signals CS<m:0> and the input/output strobe signal IO_STROBE have the activated durations which are longer than the equivalents used in the normal read operation, respectively.

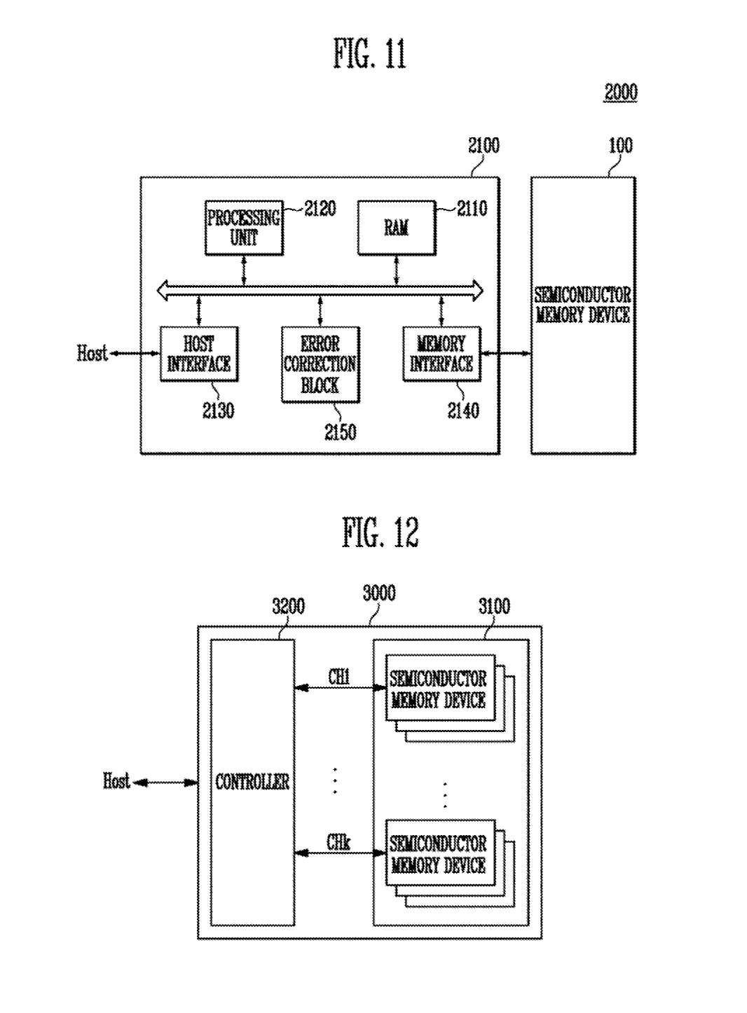

FIG. 11 is a block diagram illustrating a memory system 2000 including the semiconductor memory device 100 of FIG. 1.

With reference to FIG. 11, the memory system 2000 includes the semiconductor memory device 100 and a controller 2100.

The semiconductor memory device 100 may have the same configuration and operation as described with reference to FIG. 1. Hereinafter, repetitive description will be omitted.

The controller 2100 is connected to the host and the semiconductor memory device 100. At the request of the host, the controller 2100 may be configured to access to the semiconductor memory device 100. For example, the controller 2100 may be configured to control read, write, erase, and background operations of the semiconductor memory device 100. The controller 2100 may be configured to provide an interface between the semiconductor memory device 100 and the host. The controller 2100 may be configured to drive firmware for controlling the semiconductor memory device 100.

The controller 2100 includes a Random Access Memory (RAM) 2110, a processing unit 2120, a host interface 2130, a memory interface 2140, and an error correction block 2150. The RAM 2110 may be used as at least one of an operation memory of the processing unit 2120, a cache memory between the semiconductor memory device 100 and the host, and a buffer memory between the semiconductor memory device 100 and the host. The processing unit 2120 may control various operations of the controller 2100.

The host interface 2130 may include a protocol for performing a data exchange between the host and the controller 2100. According to an exemplary embodiment, the controller 2100 may be configured to communicate with the host through at least one of various protocols such as a Universal Serial Bus (USB) protocol, a multimedia card (MMC) protocol, a peripheral component interconnection (PCI) protocol, a PCI-express (PCI-E) protocol, an Advanced Technology Attachment (ATA) protocol, a Serial-ATA protocol, a Parallel-ATA protocol, a small computer small interface (SCSI) protocol, an enhanced small disk interface (ESDI) protocol, an Integrated Drive Electronics (IDE) protocol, and a private protocol.

The memory interface 2140 may interface with the semiconductor memory device 100. For example, the memory interface may include a NAND interface or a NOR interface.

The error correction block 2150 may perform the same function as the error correction block 210 of FIG. 1. The error correction block 2150 may be configured to detect and correct errors of the data received from the semiconductor memory device 100 using an error correcting code ECC. The processing unit 2120 may control a read voltage depending on the error detection result of the error correction block 2150 and control the semiconductor memory device 100 to perform a reread operation. According to an exemplary embodiment, the error correction block 2150 may be provided as an element of the controller 2100.

The controller 2100 and the semiconductor memory device 100 may be integrated as one semiconductor device. According to an exemplary embodiment, the controller 2100 and the semiconductor memory device 100 may be integrated into one semiconductor device to configure a memory card, such as a PC card (Personal Computer Memory Card International Association, PCMCIA), a Compact Flash Card (CF), a Smart Media Card (SM, SMC), a Memory Stick, a Multi Media Card (MMC, RS-MMC, MMCmicro), a SD Card (a SD, a miniSD, a microSD, a SDHC), and a Universal Flash Storage (UFS).

The controller 2100 and the semiconductor memory device 100 may be integrated into one semiconductor device to configure a solid state drive SSD. The SSD may include a storage device configured to store data in a semiconductor memory. If the memory system 2000 is used as the SSD, the operation speed of the host connected to the memory system 2000 may be significantly improved.

According to another embodiment, a memory system 1000 may be provided as at least one of various elements of electronic devices, such as a computer, an Ultra Mobile PC (UMPC), a workstation, a net-book, a Personal Digital Assistants (PDA), a portable computer, a web tablet, a wireless phone, a mobile phone, a smart phone, an e-book, a portable multimedia player (PMP), a portable game console, a navigation system, a black box, a digital camera, a 3-dimensional television, a digital audio recorder, a digital audio player, a digital picture recorder, a digital picture player, a digital video recorder, a digital video player, a device that can transmit or receiving information in a wireless environment, one of various electronic devices configuring a home network, one of various electronic devices configuring a computer network, one of various electronic devices configuring a telematics network, and one of various electronic devices configuring an RFID apparatus, or a computing system.

According to an exemplary embodiment, the semiconductor memory device 100 or the memory system 2000 may be installed in a various types of packages. For example, the semiconductor memory device 100 or the memory system 2000 may be packaged and installed in a form of Package on Package (PoP), Ball Grid Arrays (BGAs), Chip Scale Packages (CSPs), Plastic Leaded Chip Carrier (PLCC), Plastic Dual In Line Package (PDIP), Die in Waffle Pack, Die in Wafer Form, Chip On Board (COB), Ceramic Dual In Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), or the like.

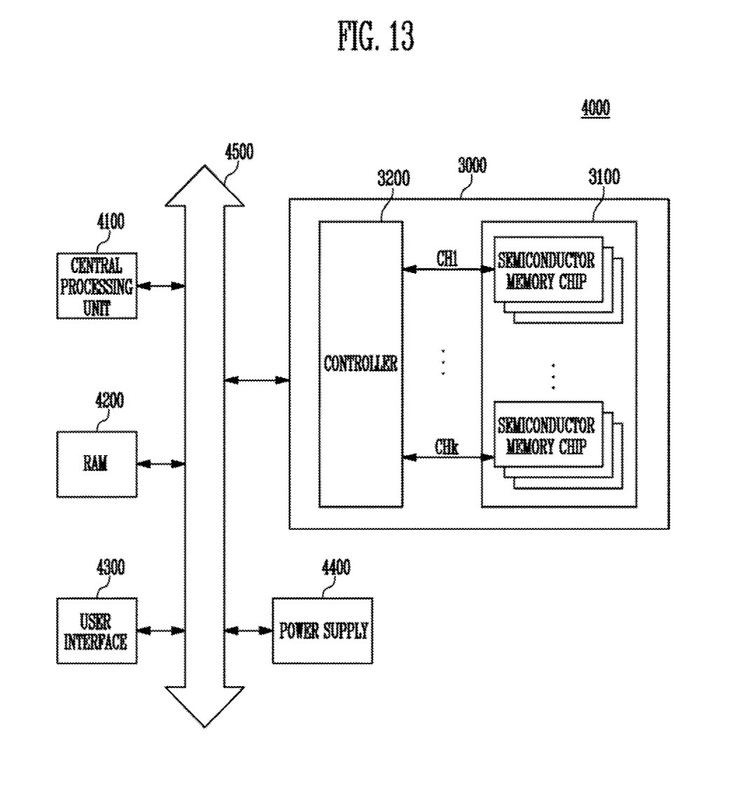

FIG. 12 is a block diagram illustrating an application example 3000 of the memory system 2000 of FIG. 11.

With reference to FIG. 12, a memory system 3000 includes a semiconductor memory device 3100 and a controller 3200. The semiconductor memory device 3100 may include a plurality of semiconductor memory chips. The plurality of semiconductor memory chips may be divided into a plurality of groups.

In FIG. 12, the plurality of groups communicate with the controller 3200 through first to k-th channels CH1 to CHk, respectively. Each of the memory chips may have the same configuration and operation as one of the semiconductor memory device 100 described with reference to FIG. 1.

Each group may be configured to communicate with the controller 3200 through one common channel. The controller 3200 may have the same configuration as the controller 2100 described with reference to FIG. 12, and be configured to control a plurality of memory chips of the semiconductor memory device 3100 through the plurality of channels CH1 to CHk.

In FIG. 12, a plurality of semiconductor memory chips are connected to one common channel. However, it should be understood that the memory system 3000 may be modified so that one semiconductor memory chip is connected to one channel.

FIG. 13 is a block diagram illustrating a computing system 4000 including the memory system 3000 of FIG. 12.

With reference to FIG. 13, the computing system 4000 includes a central processing unit 4100, a Random Access Memory (RAM) 4200, a user interface 4300, a power supply 4400, a system bus 4500, and a memory system 3000.

The memory system 3000 may be electrically connected to the central processing unit 4100, the RAM 4200, the user interface 4300, and the power supply 4400 through the system bus 4500. Data provided through the user interface 4300 or processed by the central processing unit 4100 may be stored in the memory system 3000.

In FIG. 13, the semiconductor memory device 3100 is connected to the system bus 4500 through the controller 3200.

However, the semiconductor memory device 3100 may be configured to be directly connected to the system bus 4500. At this time, functions of the controller 3200 may be performed by the central processing unit 4100 and the RAM 4200.

In FIG. 13, the memory system 3000 described with reference to FIG. 12 is provided. However, the memory system 3000 may be replaced by the memory system 2000 described with reference to FIG. 5. According to an exemplary embodiment, the computing system 4000 may be configured to include all memory systems 2000 and 3000 described with reference to FIGS. 12 and 11.

While embodiments of the present invention have been described above, it will be understood by those of ordinary skill in the art that various modifications may be made therein without departing from the original characteristics of the present invention. The scope of the present invention is not limited to the embodiments described above but rather should be understood to include various embodiments that fall within scope of the appended claims.

What is claimed is:

1. A semiconductor memory device, comprising:
a memory cell array including a plurality of memory cells;
a read and write circuit configured to store read data by sensing data stored in the plurality of memory cells and output the read data to input/output data lines in response to data read control signals, in a read operation; and
an output controller configured to control the data read control signals so that activation intervals of the data read control signals generated in a cache read operation of the read operation are longer than those generated in a normal read operation of the read operation.

2. The semiconductor memory device of claim 1, further comprising:
an I/O sense amplifier configured to receive the read data through the input/output data lines and output the read data to a global data line in response to an input/output strobe signal.

3. The semiconductor memory device of claim 2, wherein the output controller generates the input/output strobe signal.

4. The semiconductor memory device of claim 3, wherein the output controller controls the input/output strobe signal so that an activation interval of the input/output strobe signal generated in the cache read operation is longer than that generated in the normal read operation.

5. The semiconductor memory device of claim 1, wherein the output controller includes:
a pulse generating unit configured to generate an internal clock in response to a data output clock signal;
a first delay unit configured to output the internal clock without changing the activation interval or an expanded internal clock by expanding the activation interval as a delay clock, in response to a cache read flag signal;
a column decoder clock generating unit configured to generate a page buffer selecting signal in response to the delay clock; and
a column decoder configured to generate the data read control signals in response to the page buffer selecting signal and a column address.

6. The semiconductor memory device of claim 5, further including:
a sense amplifier clock generating unit configured to generate an internal input/output strobe signal in response to the delay clock; and
a second delay unit configured to output the internal input/output strobe signal without changing an activation interval of the internal input/output strobe signal or output an expanded internal input/output strobe signal by expanding an activation interval of the internal input/output strobe signal as the input/output strobe signal, in response to the cache read flag signal.

7. The semiconductor memory device of claim 5, wherein the first delay unit includes:
a delayer configured to receive the internal clock and output an expanded internal clock by expanding the activation interval; and
a multiplexer configured to output the internal clock or the expanded internal clock as the delay signal in response to the cache read flag signal.

8. The semiconductor memory device of claim 6, wherein the second delay unit includes:
a delayer configured to receive the input internal input/output strobe signal and output an expanded internal input/output strobe signal by expanding the activation interval; and
a multiplexer configured to output the internal input/output strobe signal or the expanded internal input/output strobe signal as the input/output strobe signal in response to the cache read flag signal.

9. The semiconductor memory device of claim 2, wherein the I/O sense amplifier includes:
a data sensing unit configured to sense the read data by sensing potentials of the input/output data lines and output a data out signal and an inverted data out signal depending on the sensed read data; and
a data output unit configured to transmit the read data to the global data line in response to the data out signal and the inverted data out signal.

10. The semiconductor memory device of claim 4, wherein the expanded activation intervals of the data read control signals and the expanded activation intervals of the input/output strobe signal are controlled to be the same, in the cache read operation.

11. A semiconductor memory device, comprising:
a memory cell array including a plurality of memory cells;
a read and write circuit configured to store read data by sensing data stored in the plurality of memory cells and output the read data to input/output data lines in response to data read control signals;
an I/O sense amplifier configured to receive the read data through the input/output data lines, and output the read data to the global data line in response to the input/output strobe signal; and
an output controller configured to output an expanded data read control signals and an expanded input/output strobe signal by expanding activation intervals of the data read control signals and the input/output strobe signal in response to a cache read flag signal activated in a cache read operation.

12. The semiconductor memory device of claim 11, wherein the output controller includes:
a pulse generating unit configured to generate an internal clock in response to a data output clock signal;
a first delay unit configured to output the internal clock without changing an activation interval of the internal clock or output an expanded internal clock by expanding the activation interval as a delay clock in response to a cache read flag signal;
a column decoder clock generating unit configured to generate a page buffer selecting signal in response to the delay clock; and
a column decoder configured to generate the data read control signals in response to the page buffer selecting signal and a column address.

13. The semiconductor memory device of claim 12, further including:
a sense amplifier clock generating unit configured to generate an internal input/output strobe signal in response to the delay clock; and
a second delay unit configured to output the internal input/output strobe signal without changing an activation interval of the internal input/output strobe signal or output an expanded internal input/output strobe signal by expanding the activation interval, as the input/output strobe signal, in response to the cache read flag signal.

14. The semiconductor memory device of claim 12, wherein the first delay unit includes:
a delayer configured to receive the input internal clock and output an expanded internal clock by expanding the activation interval; and
a multiplexer configured to output the internal clock or the expanded internal clock as the delay signal in response to the cache read flag signal.

15. The semiconductor memory device of claim 13, wherein the second delay unit includes:
a delayer configured to receive the internal input/output strobe signal and output an expanded internal input/output strobe signal by expanding the activation interval; and
a multiplexer configured to output the internal input/output strobe signal or the expanded internal input/output strobe signal as the input/output strobe signal in response to the cache read flag signal.

16. The semiconductor memory device of claim 11, wherein the I/O sense amplifier includes:
a data sensing unit configured to sense the read data by sensing potentials of the input/output data lines and output a data out signal and an inverted data out signal depending on the sensed read data; and
a data output unit configured to transmit the read data to the global data line in response to the data out signal and the inverted data out signal.

17. The semiconductor memory device of claim 11, wherein the expanded activation intervals of the data read control signals and the expanded activation interval of the input/output strobe signal are be controlled to be the same, in the cache read operation.

18. A memory system, comprising:
a semiconductor memory device including a plurality of memory cells, a read and write circuit connected to the plurality of memory cells through bit lines, and input output data lines connected to the read and write circuit; and
a controller configured to control the semiconductor memory device,
wherein the semiconductor memory device reads data stored in the selected memory cells in response to a request of a read operation from the controller, stores the read data in the read and write circuit, and controls a length of an interval transmitting the read data to the input/output data lines depending on whether the read operation is a normal read operation or a cache read operation.

19. The memory system of claim 18, wherein the semiconductor memory device includes:
a memory cell array including the plurality of memory cells;
a read and write circuit configured to store read data by sensing data stored in the plurality of memory cells and output the read data to input/output data lines in response to data read control signals;
an I/O sense amplifier configured to receive the read data through the input/output data lines and output the read data to a global data line in response to an input/output strobe signal; and
an output controller configured to output an expanded data read control signals and an expanded input/output strobe signal by expanding activation intervals of the data read control signals and the input/output strobe signal in response to a cache read flag signal activated in a cache read operation.

20. The memory system of claim 19, wherein the expanded activation intervals of the data read control signals and the expanded activation interval of the input/output strobe signal are controlled to be the same, in the cache read operation.
